(19) United States
(12) Patent Application Publication
(10) Pub. No.: US 2008/0251999 A1
(43) Pub. Date: Oct. 16, 2008

(54) IMAGE FORMING APPARATUS

(75) Inventors: Yuji Yamanaka, Toride-shi (JP); Taro Ikeda, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/098,743

(22) Filed: Apr. 7, 2008

(30) Foreign Application Priority Data
Apr. 12, 2007 (JP) 2007-105367

(51) Int. Cl. B65H 7/02; B41F 13/00

(52) U.S. Cl. 271/263; 271/145; 270/1.01

(57) ABSTRACT

An image forming apparatus includes a first detecting portion having an abutting portion arranged so as to abut the top surface of sheets on a sheet tray and outputs a signal for determining the presence or absence of the sheets, and a second detecting portion having an abutting portion arranged so as to abut the top surface of the sheets and outputs a signal which determines according to the position of the abutting portion whether the position of the top surface of the blown up sheets is located in a predetermined position. During the sheet feeding operation, the signal which determines that the sheets are absent is input from the first detecting portion to a controller and the signal determining that the top surface of the sheets is located in a predetermined position is not input from the second detecting portion, the controller does not determine that the sheets are absent.

### BACKGROUND OF THE INVENTION

1. Field of the Invention

The present invention relates to an image forming apparatus having a sheet feeding device which blows air onto sheets to separate and feed each of the sheets.

2. Description of the Related Art

An image forming apparatus, such as a printer or a copying machine, of the related art, has a sheet feeding device which feeds each of a plurality of sheets from a sheet storing portion which stores them. Such sheet feeding device, for instance, is of an air sheet feeding type which blows air onto the edge of a stack of sheets stored in the sheet storing portion to blow up a plurality of sheets and then absorbs only one sheet onto an absorbing and conveying belt disposed above to feed it. This technique is described in Japanese Patent Application Laid-Open No. 7-196187.

FIG. 15 illustrates an example of such sheet feeding device of the air sheet feeding type. As illustrated in FIG. 15, a sheet storage case 11 as a sheet storing portion which stores a plurality of sheets S has a sheet tray 12 which stacks the sheets S so as to be raised and lowered. Above the sheet storage case 11, there are provided an absorbing and conveying portion 50A which adsorbs and conveys each of the sheets S, and an air blowing portion 30 which blows air onto the edge of a stack of sheets on the sheet tray 12 to blow up a plurality of sheets S and separates each of the sheets.

The absorbing and conveying portion 50A has an absorbing and conveying belt 21 which is entrained around a belt driving roller 41 and absorbs each of the sheets S to feed it in the right direction in the drawing, and an absorbing fan 36 which causes a negative pressure which absorbs each of the sheets S onto the absorbing and conveying belt 21. The absorbing and conveying portion 50A has a suction duct 51 which is arranged inwardly of the adsorbing and conveying belt 21 and draws in air through a suction hole formed in the absorbing and conveying belt 21. An absorbing shutter 37 which opens or closes an air passage is arranged in a duct between the absorbing fan 36 and the suction duct 51. The absorbing shutter 37 opens the air passage to cause a negative pressure in the suction duct 51.

The air blowing portion 30 has a loosening nozzle 33 and a separating nozzle 34 which blow air onto the upper portion of the stack of stored sheets, a separating fan 31, and a separating duct 32 which conveys air from the separating fan 31 to the nozzles 33 and 34.

A part of air drawn in by the separating fan 31 in the direction of the arrows C passes through the separating duct 32 so as to be blown by the loosening nozzle 33 in the direction of the arrows D and then blows up several upper sheets of the stack of sheets stacked on the sheet tray 12. Other air is blown by the separating nozzle 34 in the direction of the arrows E and then successively separates the uppermost sheet of the sheets blown up by the loosening nozzle 33 to absorb it onto the absorbing and conveying belt 21.

Such sheet feeding device of the air sheet feeding type of the related art has a sheet presence or absence detecting portion which outputs a signal for detecting the presence or absence of the sheets S stacked on the sheet tray 12.

FIG. 16 is a diagram illustrating the configuration of such sheet presence or absence detecting portion. A sheet presence or absence detecting portion 60A has a sheet presence or absence detecting sensor lever 62 which is mounted so as to be rotatable about a support shaft 53 and can abut the top surface of the sheets S, and a sheet presence or absence detecting sensor 65 which outputs ON/OFF signals by rotation of the sheet presence or absence detecting sensor lever 62.

The sheet presence or absence detecting sensor lever 62 has an abutting portion 62A which can abut the top surface of an uppermost sheet Sa, a detecting portion 62B which light-shields the light receiving portion of the sheet presence or absence detecting sensor 65, and a stopper portion 62c. When the sheet presence or absence detecting sensor lever 62 is rotated in the direction of the sheet tray 12, the stopper portion 62c abuts an end portion 43a of a frame 43 of the sheet feeding device. Rotation of the sheet presence or absence detecting sensor lever 62 is regulated.

When rotation is regulated by the stopper portion 62c, the abutting portion 62A of the sheet presence or absence detecting sensor lever 62 is located in the lowermost position illustrated in FIG. 16.

The sheet presence or absence detecting operation of the thus-configured sheet presence or absence detecting portion 60A will be described. The sheet tray 12 which stacks the sheets is raised to perform sheet feeding. As illustrated in FIG. 17A, the abutting portion 62A of the sheet presence or absence detecting sensor lever 62 abuts the top surface of the uppermost sheet Sa to rotate the sheet presence or absence detecting sensor lever 62 upward.

The sheet tray 12 is then raised. With this, the sheet presence or absence detecting sensor lever 62 is also raised. When the distance between the absorbing and conveying belt 21 and the top surface of the uppermost sheet Sa is S1, a controller, not illustrated, stops the sheet tray 12 based on a signal from a sheet top surface detecting sensor, not illustrated.

In this state, the detecting portion 62B light-shields the light receiving portion of the sheet presence or absence detecting sensor 65. The sheet presence or absence detecting sensor 65 outputs the ON signal. When the sheet presence or absence detecting sensor 65 outputs the ON signal, the controller, not illustrated, determines based on the ON signal that the sheets S are present on the sheet tray 12.

A feeding signal for starting the sheet feeding operation is detected. As illustrated in FIG. 17B, air is blown onto the edge of the sheets S from the loosening nozzle 33, and then, several upper sheets of the sheets stacked on the sheet tray 12 are lifted. Several sheets lower than the lower end of an air blowout opening 33a of the loosening nozzle 33 are also lifted.

When the blowing up state of the sheets is stable, the distance from the absorbing surface of the absorbing and conveying belt 21 to the top surface of an unlifted sheet Sc lower than the lower end of the air blowout opening 33a is S2, which is larger than the distance S1 before lifting illustrated in FIG. 17A.

The sheet top surface detecting sensor, not illustrated, detects that the uppermost position of the sheets blown by air reaches a predetermined upper limit position or lower limit position in such a manner that the sheets are located in a predetermined range in the height direction. When air is blown so that the uppermost position of the sheets exceeds the upper limit position, the sheet tray 12 is controlled so as to be lowered to lower the uppermost position. When the uppermost position of the sheets exceeds the lower limit position, the sheet tray 12 is controlled so as to be raised to raise the uppermost position.

After the blowing up state of the sheets is stable, the absorbing operation is started. As illustrated in FIG. 17C, the uppermost sheet Sa is absorbed onto the absorbing and conveying belt 21. The absorbing and conveying belt 21 is rotated. The sheet is fed to an image forming portion, not illustrated.

Such sheet feeding is continued. When the sheets S are absent on the sheet tray 12, the abutting portion 62A of the sheet presence or absence detecting sensor lever 62 enters into a hole, not illustrated, formed in the sheet tray 12. The sheet presence or absence detecting sensor lever 62 is moved to the lowermost position illustrated in FIG. 16 and the detecting portion 62B does not light-shield the light receiving portion of the sheet presence or absence detecting sensor 65. The sheet presence or absence detecting sensor 65 outputs the OFF signal. When the sheet presence or absence detecting sensor 65 outputs the OFF signal, the controller, not illustrated, detects that the sheets S are absent on the sheet tray 12 to stop the following sheet feeding operation. A display displays that the sheets are absent on the sheet tray 12. The sheet tray 12 is lowered to the position where sheet supply is enabled.

In such sheet feeding device of the related art, when the sheets are blown up by loosen air, the amount of the loosen air blown into between the sheets can be varied due to various causes such as rotational variation of the fan and the curled state of the sheets. If the amount of blown air (air pressure) is changed, all the blown up sheets can fall suddenly.

A thin and light sheet is blown up even if the amount of blown air is small. The sheet falls even if the amount of blown air is slightly reduced. This is caused by the subtle balance of the weight of the sheet and the blowing up force by air. If the uppermost sheet falls due to a slight change in the amount of air, sheets thereunder fall sequentially and continuously. If all the sheets fall suddenly, as illustrated in FIG. 16, the top surface of the sheets stacked on the sheet tray 12 is lower than the lowermost position of the abutting portion 62A of the sheet presence or absence detecting sensor lever 62.

In this case, the sheet presence or absence detecting sensor 65 outputs the OFF signal.

Although the sheets are present on the sheet tray 12, the sheet presence or absence detecting sensor 65 outputs the OFF signal. The controller determines that the sheets are absent and then stops the sheet feeding operation. The controller lowers the sheet tray 12 to the position where sheet supply is enabled according to determination that the sheets are absent, notifies to the user that the sheets are absent, and stops the image forming apparatus until sheet supply is completed. When the sheet feeding operation is stopped due to false detection of the presence or absence of the sheets, the productivity (the number of sheets conveyed per unit time) is lowered.

### SUMMARY OF THE INVENTION

The present invention provides an image forming apparatus which can prevent false detection of the presence or absence of sheets to prevent the productivity from being lowered.

An image forming apparatus according to the present invention which blows air onto the side surface of sheets stacked on a sheet tray which can be raised and lowered so as to blow up the sheets and then absorbs and feeds each of the blown up sheets by an absorbing and conveying portion includes a first detecting portion which has an abutting portion arranged so as to abut the top surface of the sheets on the sheet tray and outputs a signal which determines the presence or absence of the sheets according to the position of the abutting portion; a second detecting portion which has an abutting portion arranged so as to abut the top surface of the sheets on the sheet tray and outputs a signal which determines according to the position of the abutting portion whether the position of the top surface of the blown up sheets on the sheet tray is located in a predetermined position; and a controller which determines the presence or absence of the sheets on the sheet tray, wherein when, during the sheet feeding operation, the signal which determines that the sheets are absent on the sheet tray is input from the first detecting portion to the controller and the signal which determines that the top surface of the sheets is located in a predetermined position is not input from the second detecting portion to the controller, the controller does not determine that the sheets are absent.

Further features of the present invention will become apparent from the following description of exemplary embodiments (with reference to the attached drawings).

### BRIEF DESCRIPTION OF THE DRAWINGS

FIG. 1 is a diagram illustrating the schematic configuration of a printer which is an example of an image forming apparatus having a sheet feeding device according to an embodiment of the present invention;

FIG. 2 is a diagram illustrating the configuration of the sheet feeding device;

FIG. 3 is a control block diagram of the sheet feeding device;

FIG. 4 is a first diagram of assistance in explaining the sheet feeding operation of the sheet feeding device;

FIG. 5 is a second diagram of assistance in explaining the sheet feeding operation of the sheet feeding device;

FIG. 6 is a third diagram of assistance in explaining the sheet feeding operation of the sheet feeding device;

FIG. 7 is a diagram of assistance in explaining the configuration of a top surface detecting mechanism provided in the sheet feeding device;

FIG. 8 is a diagram of assistance in explaining the configuration of a sheet top surface detecting sensor lever provided in the top surface detecting mechanism;

FIG. 9 is a first diagram of assistance in explaining the top surface control operation of the sheet feeding device;

FIG. 10 is a second diagram of assistance in explaining the top surface control operation of the sheet feeding device;

FIG. 11 is a third diagram of assistance in explaining the top surface control operation of the sheet feeding device;

FIG. 12 is a diagram of assistance in explaining the configuration of a sheet presence or absence detecting portion provided in the sheet feeding device;

FIG. 13 is a flowchart illustrating the sheet presence or absence detecting operation by the sheet presence or absence detecting portion;

FIG. 14 is a diagram illustrating the relation between the sheet detection height positions of the top surface detecting mechanism and the sheet presence or absence detection height positions of the sheet presence or absence detecting portion;

FIG. 15 is a diagram of assistance in explaining the configuration of a sheet feeding device of the related art;

FIG. 16 is a diagram of assistance in explaining the configuration of the sheet presence or absence detecting portion of the sheet feeding device of the related art; and

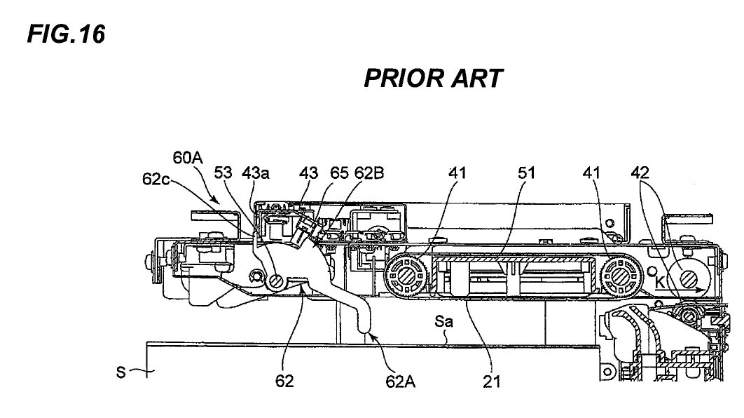

FIG. 17 is a diagram of assistance in explaining the sheet presence or absence detecting operation of the sheet presence or absence detecting portion of the sheet feeding device of the related art.

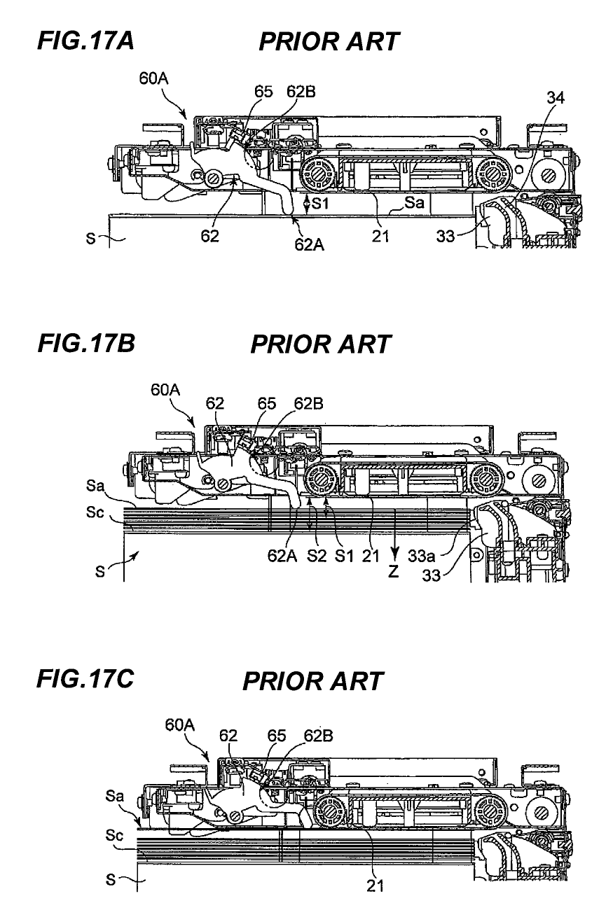

### DESCRIPTION OF THE EMBODIMENTS

An exemplary embodiment for carrying out the present invention will be described below in detail with reference to the drawings.

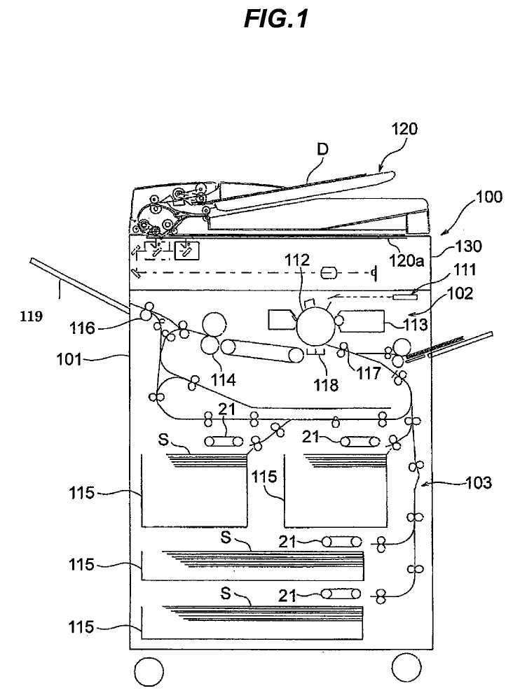

FIG. 1 is a diagram illustrating the schematic configuration of a printer which is an example of an image forming apparatus according to an embodiment of the present invention.

FIG. 1 illustrates a printer 100 and a printer body 101. Above the printer body 101, there is provided an image reading portion 130 which reads an original D placed on a platen glass 120a as an original placing platen of an automatic original conveying device 120. Below the image reading portion 130, there are provided an image forming portion 102 and a sheet feeding device 103 which feeds sheets S to the image forming portion 102.

The image forming portion 102 has a photosensitive drum 112, a development device 113, and a laser scanner unit 111. The sheet feeding device 103 has a plurality of sheet storing portions 115 which store the sheets S such as OHT and can be detachably attached to the printer body 101, and the absorbing and conveying belt 21 which is a conveying belt as an example of a sheet feeding unit which conveys the sheets S stored in the sheet storing portion 115. The configurations which absorb and convey the sheet and include the absorbing and conveying belt 21 are united. The image forming operation of the thus-configured printer 100 will be described.

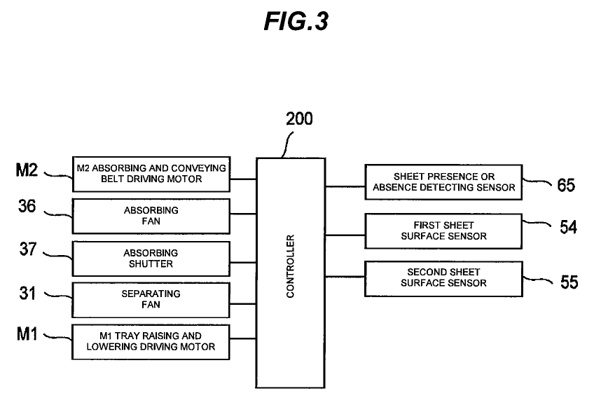

A controller to be described later illustrated in FIG. 3 and provided in the printer body 101 outputs an image reading signal to the image reading portion 130. The image reading portion 130 reads an image. The laser scanner unit 111 illuminates the photosensitive drum 112 with a laser beam corresponding to the electric signal.

The photosensitive drum 112 is previously charged and is illuminated with a light to form an electrostatic latent image. The electrostatic latent image is developed by the development device 113 to form a toner image on the photosensitive drum 112.

When the controller outputs a sheet feeding signal to the sheet feeding device 103, each of the sheets S is fed from the sheet storing portion 115. The fed sheet S is synchronized with the toner image on the photosensitive drum by a registration roller 117 and is then conveyed to a transfer portion including the photosensitive drum 112 and a transfer charger 118.

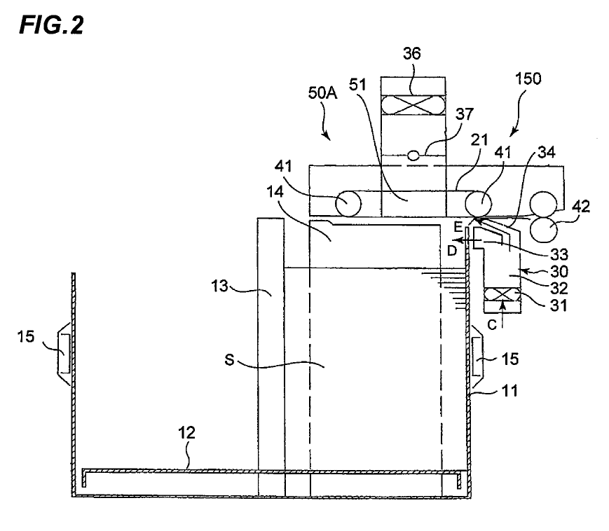

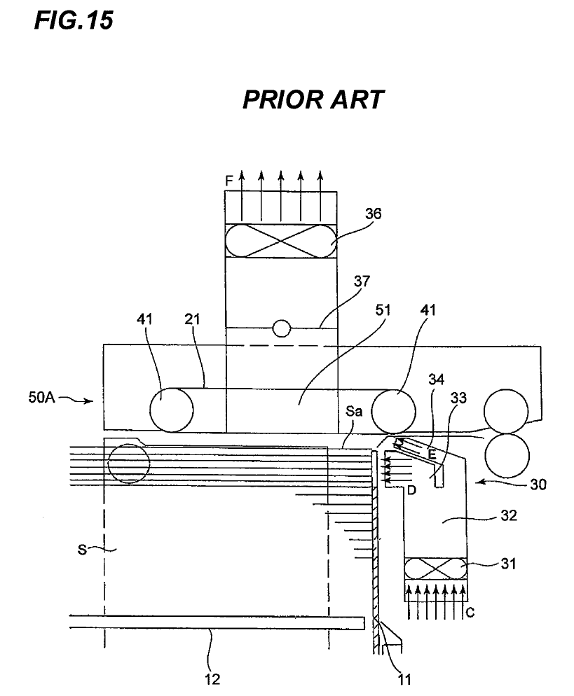

The toner image is transferred to the sheet conveyed to the transfer portion. The sheet is then conveyed to a fixing portion 114. The fixing portion 114 heats and presses the sheet. An unfixed transfer image is permanently fixed to the sheet S. The sheet to which the image is fixed is discharged by a discharge roller 116 from the printer body 101 to a discharge sheet tray 119. FIG. 2 is a diagram illustrating the configuration of the sheet feeding device 103. In FIG. 2, the same reference numerals as FIG. 15 indicate similar or equivalent parts.

The sheet storage case 11 has the sheet tray 12 provided so as to be raised and lowered, a rear edge regulating plate 13 which regulates the upstream side (rear side) in the sheet feeding direction of the sheets S, and a side edge regulating plate 14 which regulates the position in the width direction orthogonal to the sheet feeding direction of the sheets S. The positions of the rear edge regulating plate 13 and the side edge regulating plate 14 can be optionally changed according to the size of the sheets stored. The sheet storage case 11 can be drawn out from the printer body 101 by slide rails 15.

A sheet feeding mechanism of the air sheet feeding type which separates and feeds each of the sheets (hereinafter, called an air sheet feeding mechanism 150) is arranged above the sheet storage case 11. The air sheet feeding mechanism 150 has the absorbing and conveying portion 50A which is united and absorbs and conveys each of the sheets S stacked on the sheet tray 12, and the air blowing portion 30 which blows up the upper portion of a stack of sheets on the sheet tray and separates each of the sheets S.

The absorbing and conveying portion 50A has the absorbing and conveying belt 21 which is entrained around the belt driving roller 41 and absorbs each of the sheets S to feed it in the right direction in the drawing, and the absorbing fan 36 which causes a negative pressure which absorbs each of the sheets S onto the absorbing and conveying belt 21. The absorbing and conveying portion 50A has the suction duct 51 which is arranged inwardly of the absorbing and conveying belt 21 and draws in air through a suction hole, not illustrated, formed in the absorbing and conveying belt 21.

The absorbing and conveying portion 50A has the absorbing shutter 37 which is arranged between the absorbing fan 36 and the suction duct 51 and turns on and off the absorbing operation of the absorbing and conveying belt 21. In this embodiment, a plurality of the absorbing and conveying belts 21 are arranged at predetermined intervals in the width direction.

The air blowing portion 30 has the loosening nozzle 33 and the separating nozzle 34 which blow air onto the side surface of the upper portion of the stored sheets S, the separating fan 31, and the separating duct 32 which conveys air from the separating fan 31 to the nozzles 33 and 34.

A part of air drawn in by the separating fan 31 in the direction of the arrow C passes through the separating duct 32 so as to be blown by the loosening nozzle 33 in the direction of the arrow D and then blows up several upper sheets of the sheets S stacked on the sheet tray 12. Other air is blown by the separating nozzle 34 in the direction of the arrow E and then separates each of the sheets blown up by the loosening nozzle 33 to absorb it onto the absorbing and conveying belt 21.

The sheet feeding operation of the thus-configured sheet feeding device 103 (air sheet feeding mechanism 150) will be described.

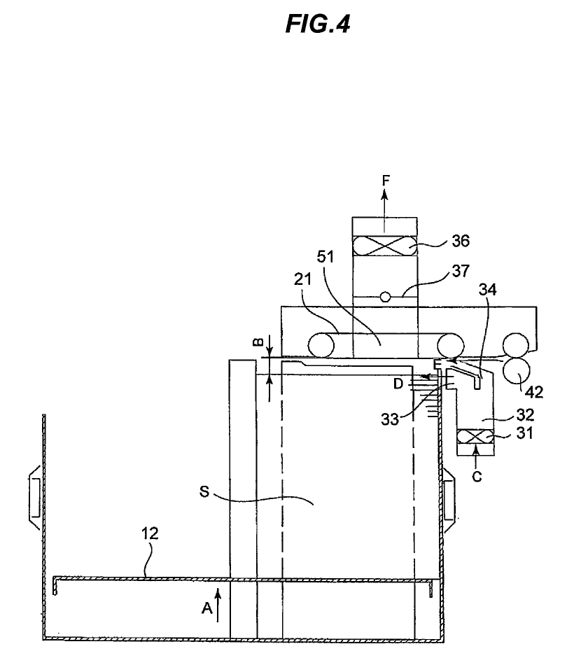

The user draws out the sheet storage case 11 to set the sheets S. As illustrated in FIG. 2, the sheets S are stored in a predetermined position. A sheet tray raising and lowering driving motor M1 is driven by a controller 200 illustrated in FIG. 3. As illustrated in FIG. 4, the sheet tray 12 starts to be raised in the direction of the arrow A. The sheet tray 12 reaches the feedable position where the distance between the sheet tray 12 and the absorbing and conveying belt 21 is B. The controller 200 stops the sheet tray 12 in this position. The controller 200 waits for the sheet feeding signal for starting sheet feeding.

Upon detection of the sheet feeding signal, the controller 200 operates the separating fan 31 to draw in air in the direction of the arrow C. The air is blown onto a stack of sheets from the loosening nozzle 33 and the separating nozzle 34 in the directions of the arrows D and E through the separating duct 32. Several upper sheets of the stack of sheets are blown up. The controller 200 operates the absorbing fan 36 to discharge air in the direction of the arrow F in the drawing. The absorbing shutter 37 is still closed.

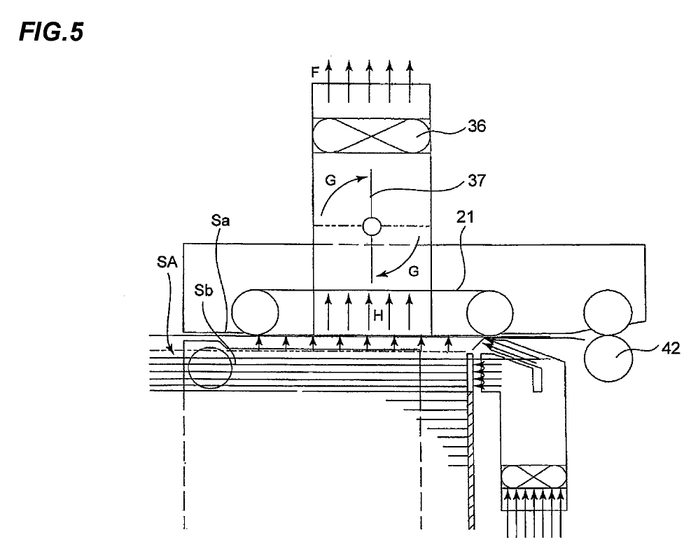

A predetermined time after detection of the feeding signal elapses. As illustrated in FIG. 5, when blowing up of upper sheets SA becomes stable, the controller 200 rotates the absorbing shutter 37 in the direction of the arrows G and then produces a suction force in the direction of the arrows H from the suction hole provided in the absorbing and conveying belt 21. Only the uppermost sheet Sa is absorbed onto the absorbing and conveying belt 21 by the absorbing force and the separating air from the separating nozzle 34.

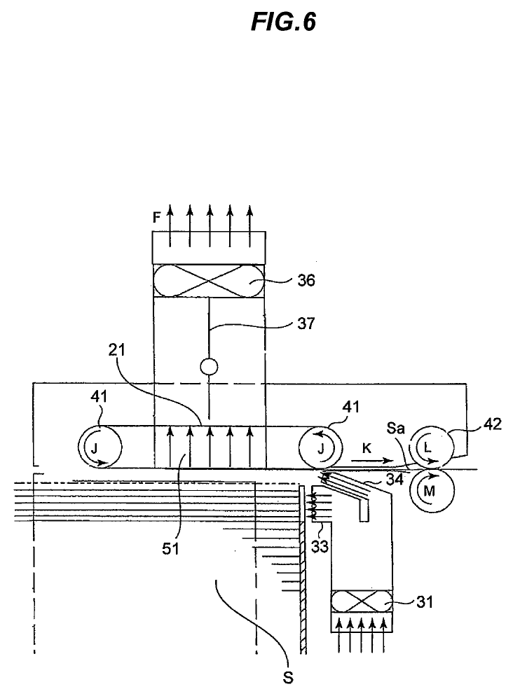

The controller 200 drives an absorbing and conveying belt driving motor M2 illustrated in FIG. 3 and, in FIG. 6, rotates the belt driving roller 41 in the direction of the arrow J. The uppermost sheet Sa absorbed onto the absorbing and conveying belt 21 is fed in the direction of the arrow K. The uppermost sheet Sa is then conveyed to the image forming portion by a pair of pulling-out rollers 42 rotated in the directions of the arrows L and M.

To absorb the sheet S onto the absorbing and conveying belt 21, the position of the top surface of the uppermost sheet Sa of the stack of sheets stored in the sheet storage case 11 need to be maintained in a predetermined position where absorption by the absorbing and conveying belt 21 is enabled. The image forming apparatus has a top surface detecting mechanism 49 as a second detecting portion which detects the position of the top surface of the sheets so as to maintain the position of the top surface of the sheets stacked on the sheet tray 12 in a predetermined position where absorption and conveying by the absorbing and conveying portion 50A are enabled.

Such top surface detecting mechanism 49 will be described.

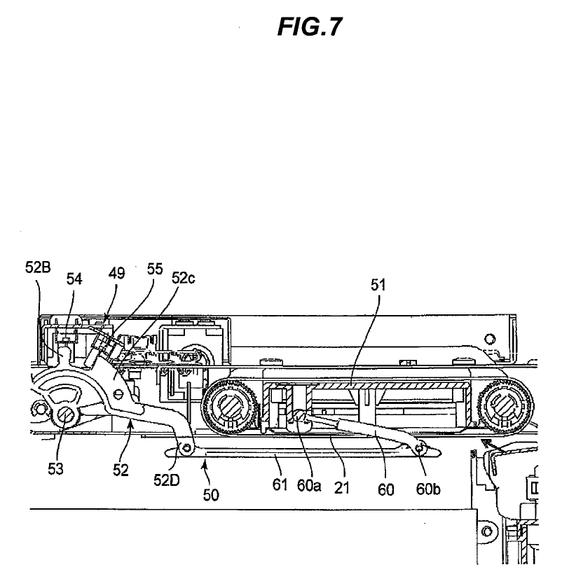

As illustrated in FIG. 7, the top surface detecting mechanism 49 has a sheet top surface detecting sensor lever 52, a first sheet top surface detecting sensor 54 and a second sheet top surface detecting sensor 55 which output ON/OFF signals by rotation of the sheet top surface detecting sensor lever 52, and a sensor lever mechanism 50. The first sheet top surface detecting sensor 54 and the second sheet top surface detecting sensor 55 are photo sensors and, as illustrated in FIG. 3, are connected to the controller 200.

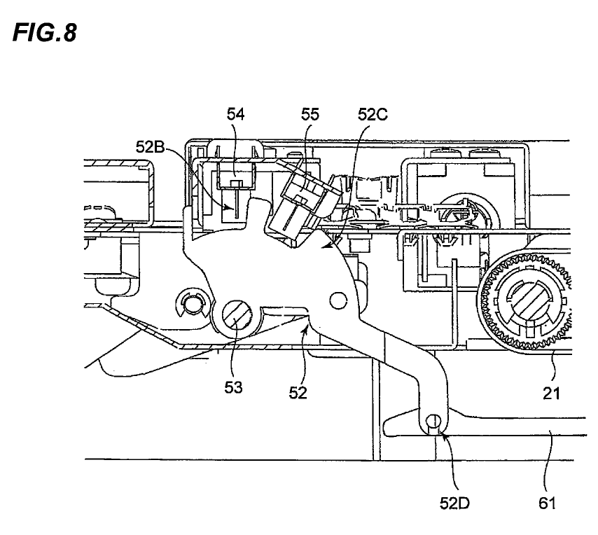

As illustrated in FIG. 8, the sheet top surface detecting sensor lever 52 is swingably supported by the support shaft 53. The sheet top surface detecting sensor lever 52 has a first detecting portion 52B which light-shields the light receiving portion of the first sheet top surface detecting sensor 54, a second detecting portion 52C which light-shields the light receiving portion of the second sheet top surface detecting sensor 55, and a supporting portion 52D which rotatably supports a sheet top surface detecting member 61 to be described later. The first sheet top surface detecting sensor 54 and the second sheet top surface detecting sensor 55 output the ON signal when they are light-shielded by the detecting portions 52B and 52C and output the OFF signal when they are not light-shielded. The OFF signal represents the state of a signal when the sensors 54 and 55 are not light-shielded and includes the case that the signal is not substantially output.

As illustrated in FIG. 7, the sensor lever mechanism 50 has a supporting member 60 which has an end 60a rotatably held in the suction duct 51, the sheet top surface detecting sensor lever 52, and the sheet top surface detecting member 61 as an abutting portion which can abut the top surface of the sheets. The sheet top surface detecting member 61 is rotatably supported by an end 60b of the supporting member 60 and the supporting portion 52D of the sheet top surface detecting sensor lever 52.

The sheet top surface detecting member 61 is provided below the absorbing and conveying region of the absorbing and conveying portion 50A so as to be parallel with the sheets S stacked on the sheet tray 12 and to be moved up and down. The supporting member 60 rotatably supported in the suction duct is protruded from a storing hole, not illustrated, formed in the gap between the plurality of absorbing and conveying belts 21 in the sheet width direction downwardly of the absorbing and conveying regions of the absorbing and conveying belts 21.

The supporting member 60, the sheet top surface detecting sensor lever 52, and the sheet top surface detecting member 61 configure a parallel link. When the sheet abuts any position of the sheet top surface detecting member 61 in the longitudinal direction, the sheet top surface detecting member 61 can maintain the parallel state (horizontal state) by swinging the sheet top surface detecting sensor lever 52 and be moved up and down. The top surface control operation based on detection of the thus-configured top surface detecting mechanism 49 will be described.

When the sheets stored in the sheet storage case 11 are lifted by raising the sheet tray 12, the top surface of the uppermost sheet Sa abuts the sheet top surface detecting member 61. When the sheet tray 12 is then raised, the sheet top surface detecting member 61 is raised with the uppermost sheet Sa. The sheet top surface detecting sensor lever 52 is swung in the direction in which the supporting portion 52D is directed upward about the support shaft 53 with the raising of the sheet top surface detecting member 61.

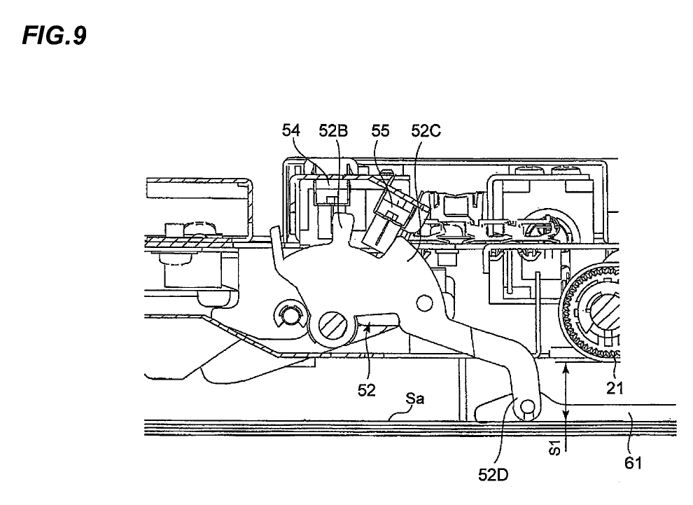

As illustrated in FIG. 9, the distance between the top surface of the raised uppermost sheet Sa and the belt surface of the absorbing and conveying belt 21 is S1. The first detecting portion 52B of the sheet top surface detecting sensor lever 52 then light-shields the first sheet top surface detecting sensor 54.

The first sheet top surface detecting sensor 54 outputs the ON signal. When the first sheet top surface detecting sensor 54 outputs the ON signal, the controller 200 stops the raising of the sheet tray 12 based on the ON signal. Here, this position is the lower limit of the lifting region. The controller 200 starts blowing of air from the air blowing portion 30 to blow up and loosen the sheets.

After the sheets are blown up, the controller 200 raises the sheet tray 12. The controller 200 determines that the sheet tray 12 is “too low” until the ON signal of the second sheet top surface detecting sensor 55 is input. The controller 200 raises the sheet tray 12 until the ON signal is input.

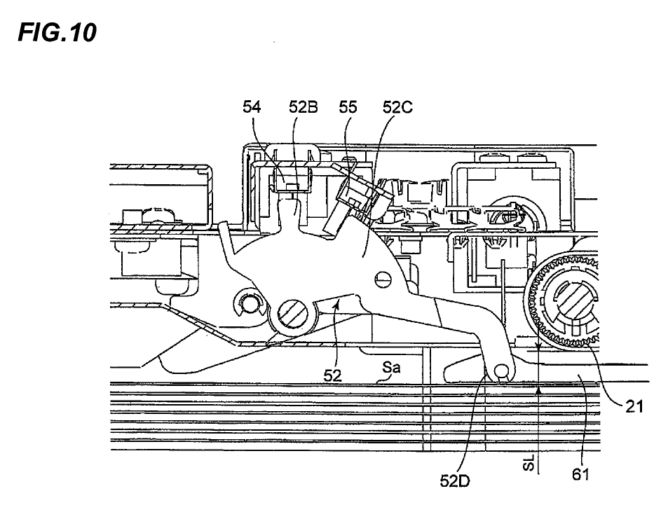

As illustrated in FIG. 10, the distance between the belt surface of the absorbing and conveying belt 21 and the top surface of the uppermost sheet Sa is SL. The second detecting portion 52C of the sheet top surface detecting sensor lever 52 then light-shields the second sheet top surface detecting sensor 55. The second sheet top surface detecting sensor 55 outputs the ON signal. When the first sheet top surface detecting sensor 54 and the second sheet top surface detecting sensor 55 output the ON signals, the controller 200 stops the raising of the sheet tray 12.

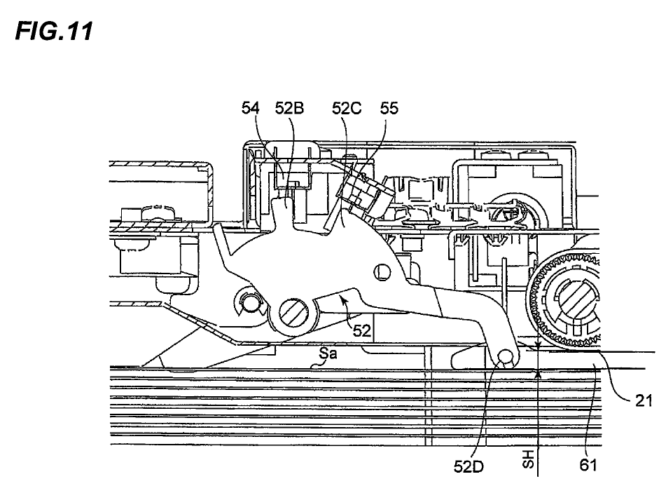

Here, this position is the upper limit of the lifting region. As illustrated in FIG. 11, the sheet tray 12 can exceed the upper limit and the distance between the belt surface of the absorbing and conveying belt 21 and the top surface of the uppermost sheet Sa can be SH. In this case, the light-shielding of the first sheet top surface detecting sensor 54 by the first detecting portion 52B of the sheet top surface detecting sensor lever 52 is released. The first sheet top surface detecting sensor 54 outputs the OFF signal. In this case the controller 200 determines that the sheet tray 12 is “too high”. The controller 200 lowers the sheet tray 12 until the ON signal of the first sheet top surface detecting sensor 54 is input.

The table below summarizes such a series of operation.

TABLE 1

| First sheet | Second sheet | |
|---|---|---|
| surface sensor 54 | surface sensor 55 | Tray operation |
| ON | OFF | Raised |
| ON | ON | Stopped |
| OFF | ON | Lowered |

The sheet tray 12 is raised and lowered based on the signals of the first and second sheet top surface detecting sensors 54 and 55. The controller 200 thus can maintain the position of the sheet tray 12 in a predetermined position where only the uppermost sheet Sa can be separated and fed. Each of the sheets S which is adsorbed by the absorbing and conveying belt 21 can be reliably separated and be fed to the image forming portion. Stable sheet feeding is thus enabled.

Such sheet feeding device has a sheet presence or absence detecting portion 70A which is a first detecting portion which detects the presence or absence of the sheets S stacked on the sheet tray 12.

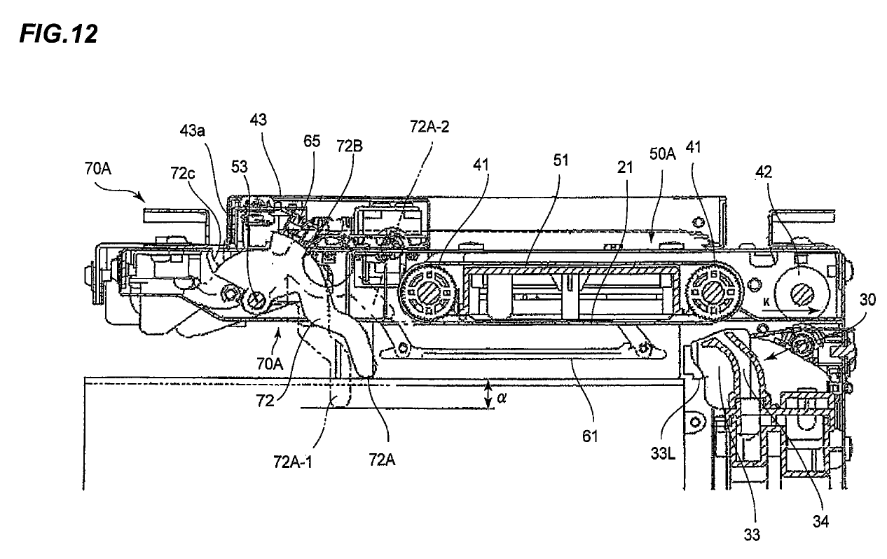

FIG. 12 is a diagram illustrating the configuration of the sheet presence or absence detecting portion 70A. The sheet presence or absence detecting portion 70A has a sheet presence or absence detecting sensor lever 72 which is rotatably supported by the support shaft 53 supporting the sheet top surface detecting sensor lever 52 and can abut the top surface of the sheets S. The sheet presence or absence detecting portion 70A also has the sheet presence or absence detecting sensor 65 which is a photo sensor and is light-shielded by rotation of the sheet presence or absence detecting sensor lever 72. As illustrated in FIG. 3, the sheet presence or absence detecting sensor 65 is connected to the controller 200.

The sheet presence or absence detecting sensor lever 72 has an abutting portion 72A which abuts the top surface of the uppermost sheet Sa, and a detecting portion 72B which light-shields the light receiving portion of the sheet presence or absence detecting sensor 65. The sheet tray 12 is raised so that the abutting portion 72A abuts the top surface of the uppermost sheet Sa stacked on the sheet tray 12.

The sheet presence or absence detecting sensor lever 72 is rotated. With this, the detecting portion 72B light-shields the light receiving portion of the sheet presence or absence detecting sensor 65. The sheet presence or absence detecting sensor 65 outputs the ON signal. The signal is used for the controller 200 to determine that the sheets S are present on the sheet tray.

When the sheets S are absent on the sheet tray 12, the abutting portion 72A of the sheet presence or absence detecting sensor lever 72 is rotated so as to enter into a hole, not illustrated, formed in the sheet tray 12. The light shielding of the light receiving portion of the sheet presence or absence detecting sensor 65 by the detecting portion 72B is released. The sheet presence or absence detecting sensor 65 outputs the OFF signal. The signal is used for the controller 200 to determine that the sheets S are absent on the sheet tray. The OFF signal represents the state of a signal when the sensors 54 and 55 are not light-shielded and includes the case that the signal is not substantially output.

A stopper 72c is formed at the end of the sheet presence or absence detecting sensor lever 72. The stopper 72c abuts the end portion 43a of the frame 43 of the sheet feeding device to regulate rotation of the sheet presence or absence detecting sensor lever 72. When rotation is regulated, the position of the abutting portion 72A of the sheet presence or absence detecting sensor lever 72 is the lowermost position indicated by an alternate long and two short dashes line 72A-1.

Typically, the abutting portion 72A of the sheet presence or absence detecting sensor lever 72 is located in the lowermost position when the sheets are absent on the sheet tray 12 and the abutting portion 72A enters into the hole, not illustrated, formed in the sheet tray 12.

When air is blown from the loosening nozzle 33, the sheet Sc lower than a lower end 33L is not blown up. Typically, the position of the last sheet of the stacked sheets is not lower than the lower end 33L and the upper surface of the sheet tray 12 when the last sheet is conveyed is not lower than the lower end 33L.

If the presence or absence of the sheet can be detected in the position of the lower end 33L, the presence or absence of the sheets on the sheet tray 12 can be reliably detected. In this embodiment, the presence or absence of the sheets is detected in the position of the sheet which is not blown up by blowing air so as to detect the presence or absence of the sheets S on the sheet tray 12.

The abutting portion 72A of the sheet presence or absence detecting sensor lever 72 is protruded downward from the lower end 33L of the air blowout opening 33a by a distance a with a sufficient space. The presence or absence of the sheets S can be continuously and reliably detected during the sheet feeding operation.

The length between the support shaft 53 and the abutting portion 72A of the sheet presence or absence detecting sensor lever 72 is set to satisfy the following conditions. In FIG. 12, a dotted line 72A-2 indicates a stored state that the abutting portion 72A of the sheet presence or absence detecting sensor lever 72 is stored when the absorbing and conveying belt 21 adsorbs and feeds the sheet.

(1) When the abutting portion 72A of the sheet presence or absence detecting sensor lever 72 is located in the lowermost position, it is lower than the lower end 33L of the blowout opening 33a which blows out air of the loosening nozzle 33.

(2) The sheet presence or absence detecting sensor lever 72 need to be stored so that the sheet tray 12 can be drawn out without being caught. In the stored state, the abutting portion 72A should not interfere with the absorbing and conveying portion 50A. The sheet presence or absence detecting sensor lever 72 should not be protruded upward from the united absorbing and conveying portion 50A. The sheet presence or absence detecting sensor lever 72 need to be stored in the united absorbing and conveying portion 50A.

(3) The abutting portion 72A of the sheet presence or absence detecting sensor lever 72 can abut the top surface of the uppermost sheet Sa on the upstream side from the absorbing surface of the absorbing and conveying belt 21 and on the downstream side from the rear edge of a small sheet which can be stored in the sheet storage case 11.

By the above setting, the distance a in which the abutting portion 72A of the sheet presence or absence detecting sensor lever 72 is protruded downward from the lower end 33L of the air blowout opening 33a is restricted to some degree. As described in the problem of the image forming apparatus of the related art, when the blown up sheets fall suddenly, the abutting portion 72A of the sheet presence or absence detecting sensor lever 72 reaches the lowermost position so that the sheet presence or absence detecting sensor 75 can output the OFF signal. To address this problem, in this embodiment, the control by the controller 200 is performed as follows.

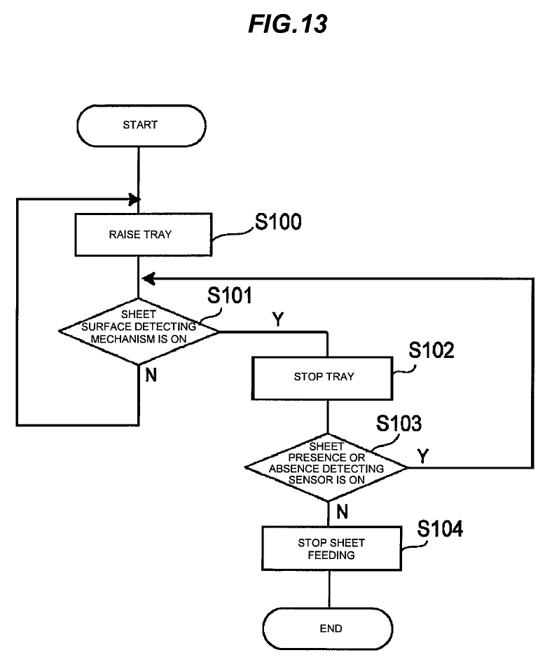

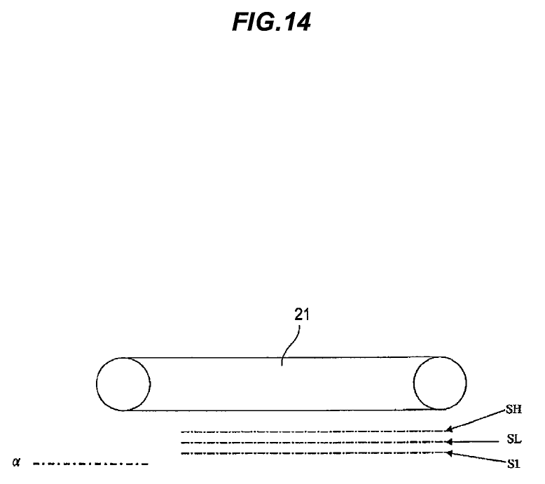

This will be described with reference to a flowchart illustrating the sheet presence or absence detecting operation in FIG. 13. When the sheet feeding operation is started, the controller 200 drives the sheet tray raising and lowering driving motor M1 to raise the sheet tray 12 (S100) and then determines whether or not the top surface detecting mechanism 49 detects the top surface, that is, whether it outputs the ON signal (S101). The top surface detecting mechanism 49 outputs the ON signal in the region above S1, illustrated in FIG. 14. Either or both of the first sheet top surface detecting sensor 54 and the second sheet top surface detecting sensor 55 outputs the ON signal.

When the top surface detecting mechanism 49 outputs the ON signal (Y in S101), the sheet tray 12 is stopped (S102). Sheet feeding is then started. It is detected whether or not the sheet presence or absence detecting sensor 65 outputs the ON signal (S103). When the sheet presence or absence detecting sensor 65 outputs the ON signal (Y in S103), it is determined that the sheets are present. When the sheet presence or absence detecting sensor 65 outputs the OFF signal (N in S103), sheet feeding is stopped (S104).

FIG. 14 is a diagram illustrating the relation between the sheet detection height positions (SH, SL, and S1) of the top surface detecting mechanism 49 and the sheet presence or absence detection height positions of the sheet presence or absence detecting portion 70A. In this embodiment, the sheet presence or absence detection positions of the sheet presence or absence detecting portion 70A are set to be lower than the sheet detection height positions of the top surface detecting mechanism 49.

In such configuration, when the sheets are absent during sheet feeding, the top surface detecting mechanism 49 detects the upper surface of the sheet tray 12 to output the ON signal and the sheet presence or absence detecting portion 70A outputs the OFF signal.

During sheet feeding, as already described, the blown up sheets can fall suddenly. When the abutting portion 72A of the sheet presence or absence detecting sensor lever 72 is located in the lowermost position due to falling of the blown up sheets, the sheet presence or absence detecting portion 70A outputs the OFF signal and the top surface detecting mechanism 49 also outputs the OFF signal. When the sheet presence or absence detecting portion 70A outputs the OFF signal and the top surface detecting mechanism 49 also outputs the OFF signal, it cannot be determined that the sheets are absent.

In this embodiment, the controller 200 determines the presence or absence of the sheets based on Table 2.

TABLE 2

| Detection of the | | |
|---|---|---|
| presence or | Detection of | |
| absence of sheets | sheet surface | |
| ON | ON | Presence of |
| | | sheets |
| ON | OFF | Presence of |
| | | sheets |
| OFF | ON | Absence of sheets |
| OFF | OFF | Not determined |

During the sheet feeding operation, the sheet presence or absence detecting sensor 65 outputs the OFF signal and the top surface detecting mechanism 49 outputs the ON signal. It is determined that the sheets are absent because the sheets are absent on the sheet tray 12 and the top surface detecting mechanism 49 detects the upper surface of the sheet tray 12. The controller 200 determines that the sheets are absent when the signal which determines that the sheets are absent on the sheet tray 12 is input from the sheet presence or absence detecting sensor 65 and the signal which determines that the top surface of the sheets is located at a predetermined height is input from the top surface detecting mechanism 49. The abutting portion 72A of the sheet presence or absence detecting sensor lever 72 enters into the hole, not illustrated, of the sheet tray 12 and is located in the lowermost position. The sensor lever mechanism 50 of the top surface detecting mechanism 49 abuts the upper surface of the sheet tray 12 which has conveyed the last sheet. The controller 200 thus determines that the sheets are absent on the sheet tray 12.

During the sheet feeding operation, the sheet presence or absence detecting sensor 65 outputs the OFF signal and the top surface detecting mechanism 49 outputs the OFF signal. In this case it is not determined that the sheets are absent. This is because the sheets are present on the sheet tray 12 and the blown up sheets can fall suddenly. The controller 200 does not determine that the sheets are absent when the signal which determines that the sheets are absent on the sheet tray 12 is input from the sheet presence or absence detecting sensor 65 and the signal which determines that the top surface of the sheets is located at a predetermined height is input from the top surface detecting mechanism 49. The controller 200 cannot determine the presence or absence of the sheets because the sensor lever mechanism 50 of the top surface detecting mechanism 49 does not abut the upper surface of the sheet tray 12 while the abutting portion 72A of the sheet presence or absence detecting sensor lever 72 enters into the hole, not illustrated, formed in the sheet tray 12.

When the controller 200 cannot determine the presence or absence of the sheets, it controls the sheet tray 12 so as to be raised. When the sheet tray 12 is raised and the sheet presence or absence detecting sensor 65 then outputs the ON signal, it is determined that the sheets are present. The sheet tray 12 is then raised until both the first sheet top surface detecting sensor 54 and the second sheet top surface detecting sensor 55 output the ON signals. The top surface of the uppermost sheet is located in a predetermined position. Sheet feeding can be continuously performed to form an image without stopping the operation of the image forming apparatus due to false determination that the sheets are absent.

When the top surface detecting mechanism 49 outputs the ON signal while the sheet tray 12 is raised and the sheet presence or absence detecting sensor 65 outputs the OFF signal, it is determined that the sheets are absent. As described above, the sensor lever mechanism 50 abuts the upper surface of the sheet tray 12 while the sheets are absent.

In such control, even if the blown up sheets fall suddenly, false detection which determines that the sheets are absent although the sheets are present can be prevented. The lowering of the productivity due to the false detection of the presence or absence of the sheets can be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-105367, filed Apr. 12, 2007 which is hereby incorporated by reference herein in its entirety.

What is claimed is:

1. An image forming apparatus which blows air onto edge of sheets stacked on a sheet tray which can be raised and lowered so as to blow up the sheets and then absorbs and feeds each of the blown up sheets by an absorbing and conveying portion, comprising:
a first detecting portion which has an abutting portion arranged so as to abut the top surface of the sheets on the sheet tray and outputs a signal which determines the presence or absence of the sheets according to the position of the abutting portion;
a second detecting portion which has an abutting portion arranged so as to abut the top surface of the sheets on the sheet tray and outputs a signal which determines according to the position of the abutting portion whether the position of the top surface of the blown up sheets on the sheet tray is located in a predetermined position; and
a controller which determines the presence or absence of the sheets on the sheet tray,
wherein, during the sheet feeding operation, the signal which determines that the sheets are absent on the sheet tray is input from the first detecting portion to the controller and the signal which determines that the top surface of the sheets is located in a predetermined position is not input from the second detecting portion to the controller, the controller does not determine that the sheets are absent.

2. The image forming apparatus according to claim 1, wherein when the signal which determines that the sheets are absent is input from the first detecting portion and the signal which determines that the top surface of the blown up sheets is located in a predetermined position is not input from the second detecting portion, the controller raises and lowers the sheet tray until the signal which determines that the top surface of the sheets is located in a predetermined position is input from the second detecting portion.

3. The image forming apparatus according to claim 1, wherein when, during the sheet feeding operation, the signal which determines that the sheets are absent on the sheet tray is input from the first detecting portion and the signal which determines that the position of the top surface of the sheets is located in a predetermined position is input from the second detecting portion, the controller determines that the sheets are absent.

4. The image forming apparatus according to claim 1, wherein when the controller determines based on the signal output from the second detecting portion that the top surface of the sheets on the sheet tray is not located in a predetermined position, the controller raises and lowers the sheet tray and maintains the position of the top surface of the blown up sheets in a predetermined position where absorption and conveying by the absorbing and conveying portion are enabled.

5. An image forming apparatus which blows air onto edge of sheets stacked on a sheet tray which can be raised and lowered so as to blow up the sheets and then absorbs and feeds each of the blown sheets by an absorbing and conveying portion, comprising:
a first detecting portion which has an abutting portion arranged so as to abut the top surface of the sheets on the sheet tray and outputs a signal which determines the presence or absence of the sheets according to the position of the abutting portion;
a second detecting portion which has an abutting portion arranged so as to abut the top surface of the sheets on the sheet tray and outputs a signal which determines according to the position of the abutting portion whether the position of the top surface of the blown up sheets on the sheet tray is located in a predetermined position; and
a controller which determines the presence or absence of the sheets on the sheet tray,
wherein only when the signal which determines that the sheets are absent on the sheet tray is input from the first detecting portion to the controller and the signal which determines that the top surface of the sheets is located in a predetermined position is input from the second detecting portion to the controller, the controller determines that the sheets are absent.

6. The image forming apparatus according to claim 5, wherein when the signal which determines that the sheets are absent is input from the first detecting portion and the signal which determines that the top surface of the blown up sheets is located in a predetermined position is not input from the second detecting portion, the controller raises and lowers the sheet tray until the signal which determines that the top surface of the sheets is located in a predetermined position is input from the second detecting portion.

7. The image forming apparatus according to claim 1 or 5, wherein the first detecting portion has a photo sensor and a sensor lever which can light-shield the photo sensor, and the sheet tray has a hole into which the sensor lever enters.
